(19) United States
(12) Patent Application Publication
(10) Pub. No.: US 2019/0347385 A1
(43) Pub. Date: Nov. 14, 2019

(54) SECURITY METHODS AND SYSTEMS BY CODE MUTATION

(71) Applicant: Asaf SHELLY, Yehud (IL)

(72) Inventor: Asaf SHELLY, Yehud (IL)

(21) Appl. No.: 16/307,497

(22) PCT Filed: May 4, 2017
(86) PCT No.: PCT/IL2017/050490

§ 371 Date: Dec. 6, 2018

Related U.S. Application Data
(60) Provisional application No. 62/346,656, filed on Jun. 7, 2016.
(60) Provisional application No. 62/472,020, filed on Mar. 16, 2017.

(51) Int. Cl. G06F 21/14; G06F 21/55

(52) U.S. Cl. CPC G06F 21/14; G06F 2221/033; G06F 2221/0742; G06F 21/554

(57) ABSTRACT

A method comprising: (a) receiving a machine-readable functional requirement as an input at a data processor, (b) producing, by an algorithm running on said data processor, a machine-readable functional requirement, to produce at least one machine-readable mutated copy of said functional requirement, each of said at least one mutated copies retaining the function of the input, as a product at said data processor, and (c) providing one or more of said mutated copies as an output.

### FIELD OF THE INVENTION

The invention is in the field of computer security.

### BACKGROUND OF THE INVENTION

Computer hackers attempt to infiltrate a system by locating a software vulnerability that can be accessed using a public interface. The next stage of infiltration requires knowledge of the code organization of the attacked software. At that stage, an attacker attempts to seize control over the system by redirecting the execution path to perform an action that was not intended by the software producer. This is commonly done by redirecting the system's processor to execute alternate code.

In some hacking strategies, alternate code includes denial of one or more legitimate operations provided by the software producer.

Alternatively or additionally, in some hacking strategies, alternate code includes injection of new processor code to the system.

### SUMMARY OF THE INVENTION

A broad aspect of the invention relates increasing a level of protection against attacks by hackers.

One aspect of some embodiments of the invention relates to producing multiple copies of binary code with a same function, where the copies are different from one another. According to various exemplary embodiments of the invention, differences among copies are produced by changing an offset and/or employing a random number generator and/or employing different memory locations for a same block of code in each copy and/or splitting a block of code into two or more memory locations.

Another aspect of some embodiments of the invention relates to distribution of the copies of binary code with a same function, where the copies are different from one another, among a plurality of devices.

Another aspect of some embodiments of the invention relates to serial use of the copies of binary code with a same function, where the copies are different from one another, for successive iterations of the function on a single device.

It will be appreciated that the various aspects described above relate to solution of technical problems associated with susceptibility of computer software to various types of hacking.

Alternatively or additionally, it will be appreciated that the various aspects described above relate to solution of technical problems related to reducing efforts by software developers to achieve a reasonable degree of protection against attacks.

Alternatively or additionally, it will be appreciated that the various aspects described above relate to solution of technical problems arising from the conventional practice of storing a single memory object in a single memory location.

Alternatively or additionally, it will be appreciated that the various aspects described above relate to solution of technical problems arising from use of identical code in a large number of devices.

In some exemplary embodiments of the invention there is provided a method including: (a) receiving a machine-readable functional requirement as an input at a data processor, (b) implementing, by an algorithm running on the data processor, a change in the machine-readable functional requirement to produce at least one machine-readable mutated copy of the functional requirement, each of the at least one mutated copies retaining the function of the input, as a product at the data processor, (c) providing one or more of the mutated copies as an output. Alternatively or additionally, in some embodiments the method includes producing two or more machine-readable copies of the functional requirement that differ from one another. Alternatively or additionally, in some embodiments the method includes producing only one machine-readable copy of the functional requirement. Alternatively or additionally, in some embodiments the input comprises software code (source code) and comprising compiling the copies to produce binary code. Alternatively or additionally, in some embodiments the input comprises binary code. Alternatively or additionally, in some embodiments the input comprises binary description. Alternatively or additionally, in some embodiments the input comprises functional requirements and mutation metadata. Alternatively or additionally, in some embodiments the input comprises a file describing information required by mutation. Alternatively or additionally, in some embodiments the method includes transmitting the output to an external device. Alternatively or additionally, in some embodiments the method includes incorporating the output into a program running on a device in which the data processor resides. Alternatively or additionally, in some embodiments the copies of the output are used successively by a same device. Alternatively or additionally, in some embodiments the copies of the output comprise data cookies. Alternatively or additionally, in some embodiments the algorithm running on the data processor changes the functional requirement by changing the order of data in the functional requirement. Alternatively or additionally, in some embodiments the algorithm running on the data processor changes the functional requirement to change a behavior of a random number generator in the product functional requirements. Alternatively or additionally, in some embodiments the algorithm running on the data processor changes the functional requirement by introducing one or more random number generation mechanisms to the product functional requirements. Alternatively or additionally, in some embodiments the algorithm running on the data processor employs a random number generator to change the functional requirements. Alternatively or additionally, in some embodiments the algorithm running on the data processor employs two or more random number generation mechanisms to change the functional requirements. Alternatively or additionally, in some embodiments the algorithm running on the data processor employs different memory locations for a same block of code in each copy. Alternatively or additionally, in some embodiments the algorithm running on the data processor splits one or more buffers into multiple memory locations.

In some exemplary embodiments of the invention there is provided a method including: (a) receiving a machine-readable functional requirement in the format of binary-description as an input at a data processor, (b) implementing, by an algorithm running on the data processor, a generation of machine-readable functional requirement by integration of fragments of software code (source code) based on description found in input machine-readable functional requirement, to produce at least one machine-readable mutated copy of the functional requirement, each of the at least one mutated copies retaining the function of the input, as a product at the data processor, (c) providing one or more of the mutated copies as an output. Alternatively or additionally, in some embodiments the method includes producing two or more machine-readable copies of the functional requirement that differ from one another. Alternatively or additionally, in some embodiments the method includes producing only one machine-readable copy of the functional requirement. Alternatively or additionally, in some embodiments the output comprises software code (source code) and comprising compiling the copies to produce binary code. Alternatively or additionally, in some embodiments the input comprises functional requirements and a software code (source code) to be integrated with the product functional requirements. Alternatively or additionally, in some embodiments the input comprises functional requirements of any format and a mutation metadata. Alternatively or additionally, in some embodiments the input comprises a file describing information required by mutation. Alternatively or additionally, in some embodiments the method includes transmitting the output to an external device. Alternatively or additionally, in some embodiments the method includes incorporating the output into a program running on a device in which the data processor resides. Alternatively or additionally, in some embodiments the copies of the output are used successively by a same device. Alternatively or additionally, in some embodiments the copies of the output comprise data cookies. Alternatively or additionally, in some embodiments the algorithm running on the data processor changes the functional requirement by changing the order of data in the functional requirement. Alternatively or additionally, in some embodiments the algorithm running on the data processor changes the functional requirement to change a behavior of a random number generator in the product functional requirements. Alternatively or additionally, in some embodiments the algorithm running on the data processor changes the functional requirement by introducing two or more random number generation mechanisms to the product functional requirements. Alternatively or additionally, in some embodiments the algorithm running on the data processor employs different memory locations for a same block of code in each copy. Alternatively or additionally, in some embodiments the algorithm running on the data processor splits one or more buffers into multiple memory locations.

In some exemplary embodiments of the invention there is provided a method including: (a) storing a machine-readable functional requirement in a memory of a data processor, (b) implementing, by an algorithm running on the data processor a change in the machine-readable functional requirement to produce multiple copies of mutated functional requirement, each of the copies retaining the function of the input, wherein the copies differ from one another; and (c) transferring individual copies from among the copies to a plurality of devices and installing the individual copies on the devices to impart the function to the devices. In some embodiments the machine-readable functional requirement comprises software code (source code) and comprising compiling the copies to produce binary code. Alternatively or additionally, in some embodiments the input comprises binary code. Alternatively or additionally, in some embodiments the plurality of devices includes Internet of Things (IOT) device. Alternatively or additionally, in some embodiments the copies of the output are used successively by a same device. Alternatively or additionally, in some embodiments the algorithm running on the data processor changes the functional requirement by changing an offset of data in a memory of the device. Alternatively or additionally, in some embodiments the algorithm running on the data processor changes the functional requirement to change a behavior of a random number generator in the product functional requirements. Alternatively or additionally, in some embodiments the algorithm running on the data processor changes the functional requirement by introducing one or more random number generation mechanisms to the product functional requirements. Alternatively or additionally, in some embodiments the algorithm running on the data processor employs a random number generator to change the functional requirements. Alternatively or additionally, in some embodiments the algorithm running on the data processor employs two or more random number generation mechanisms to change the functional requirements. Alternatively or additionally, in some embodiments the algorithm running on the data processor employs different memory locations for a same block of code in each copy. Alternatively or additionally, in some embodiments the algorithm running on the data processor splits one or more buffers into multiple memory locations. Alternatively or additionally, in some embodiments the IOT device resides in a vehicle. Alternatively or additionally, in some embodiments the vehicle is an Unmanned Aerial Vehicle. Alternatively or additionally, in some embodiments the device is managed by a Command and Control Interface. Alternatively or additionally, in some embodiments IOT device resides in a medical device. Alternatively or additionally, in some embodiments the IOT device resides in a smart home. Alternatively or additionally, in some embodiments the IOT device receives said copy wirelessly (OTA update—over the air). Alternatively or additionally, in some embodiments the IOT device is connected to a cellular network. Alternatively or additionally, in some embodiments the IOT device performs at least some functionality of a SIM Card.

In some exemplary embodiments of the invention there is provided a system comprising: a plurality of data processing devices running binary code to perform a same function, wherein at least one of the devices runs binary code which is different from binary code on at least one other device to perform the same function; and (b) an output module on each of the devices, the output module transferring output in a same format to a remote server. In some embodiments, the plurality of data processing devices comprises Internet of Things (IOT) devices. Alternatively or additionally, in some embodiments at least some of the IOT devices reside in a vehicle. Alternatively or additionally, in some embodiments the IOT device resides in a medical device. Alternatively or additionally, in some embodiments the IOT device resides in a smart home. In some exemplary embodiments of the invention there is provided a system comprising of a device having a processor running binary code to perform a function, wherein at least one internal behavior of the device running the binary code is different from at least one same device running the same binary code to perform said same function; and (b) an output module on each of said devices, said output module transferring output in a same format to a remote server. In some embodiments, the processor has a dedicated processor instruction to support said change in behavior. Alternatively or additionally, in some embodiments a dedicated hardware component is used to support said change in behavior.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and not limiting.

For purpose of this specification and the accompanying claims, the term “functional requirements” means information describing the functionality, behavior and interfaces of a system executing a software, in response to inputs and events. Binary code is the lowest abstraction of “functional requirement”, describing in specific detail how internal processor components are used. A higher abstraction of “functional requirement” is software source code, which describes the binary code generated by a compiler. A higher abstraction of “functional requirement” is software-documentation such as “software design document” (SDD), “flow chart”, and “sequence diagram”. A higher abstraction of “functional requirement” is product-definition-documentation, system-architecture-documentation and a binary file containing options edited in a dedicated tool. Functional-requirement can have one or more figures, text documents, and binary information.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a simplified flow diagram of a method according to some exemplary embodiments of the invention;

FIG. 2 is a simplified flow diagram of a method according to some exemplary embodiments of the invention;

FIG. 3 is a schematic representation of a system according to some exemplary embodiments of the invention;

FIG. 4 is a schematic representation of RAM memory according to one exemplary embodiment of the invention; and

FIG. 5 is a schematic representation of RAM memory according to one exemplary embodiment of the invention.

### DETAILED DESCRIPTION OF EMBODIMENTS

Embodiments of the invention relate to computerized methods and systems.

Specifically, some embodiments of the invention can be used to decrease vulnerability to a security breach (hacking attack) by making it more difficult for the attacker (hacker) to understand the way in which a device operates in response to an event; and the way program data is organized and stored on the device under attack.

First Exemplary Method

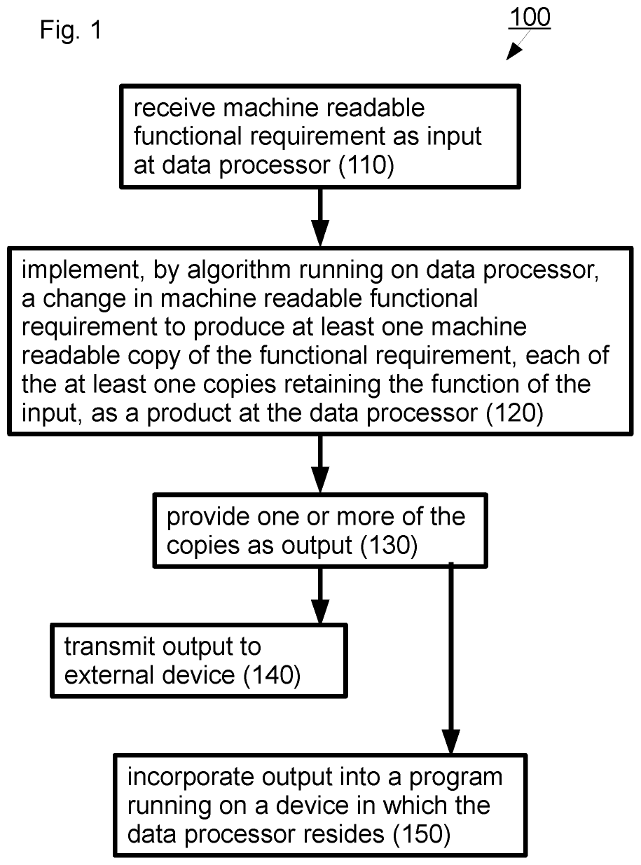

FIG. 1 is a simplified flow diagram of a cybersecurity method, indicated generally as 100, according to some exemplary embodiments of the invention.

Depicted exemplary method 100 includes receiving 110 a machine-readable functional requirement as an input at a data processor. Exemplary formats for the input are described hereinbelow.

In the depicted embodiment, method 100 includes implementing 120, by an algorithm running on the data processor, a change in the machine-readable functional requirement to produce at least one machine-readable mutated copy of the functional requirement as a product at said data processor. Each of the at least one (mutated) copies retains the function of the input.

Depicted exemplary method 100 includes providing 130 one or more of the (mutated) copies as an output.

In some exemplary embodiments of the invention, method 100 includes producing two or more machine-readable (mutated) copies of said functional requirement, which differ from one another. In some exemplary embodiments of the invention, method 100 includes only one mutated machine-readable copy of the functional requirement. In cases where a single copy is produced, it differs from the input by virtue of the mutation. Production of a single mutated copy is useful, for example, in run-time implementations. According to these embodiments, each iterative launch of a program (or portion thereof) produces a single new copy with at least one mutation relative to the previous version. In some embodiments, the previous version is stored for maintenance and debug purposes.

In some exemplary embodiments of the invention, the input includes software code (source code) and the method includes compiling the copies to produce binary code. Alternatively or additionally, in some embodiments the input includes binary code.

In some exemplary embodiments of the invention, method 100 includes transmitting 140 the output to an external device (external to the device on which the data processor resides). External devices include Internet of Things (IOT) devices, personal computers, tablets, phones and servers (cloud or conventional). In some embodiments, output is self-extracting and/or self-installing.

In other exemplary embodiments of the invention, method 100 includes incorporating 150 output into a program running on a device in which the data processor resides.

In some exemplary embodiments of the invention, the (mutated) copies of the output are used successively by a same device. For example, in some embodiments an on-line banking application residing on a user client device (e.g. a smart phone) runs a different copy (with a different mutation or set of mutations) of code for successive transactions. Alternatively or additionally, a bank server runs a different copy (with a different mutation or set of mutations) of code for successive transactions.

Second Exemplary Method

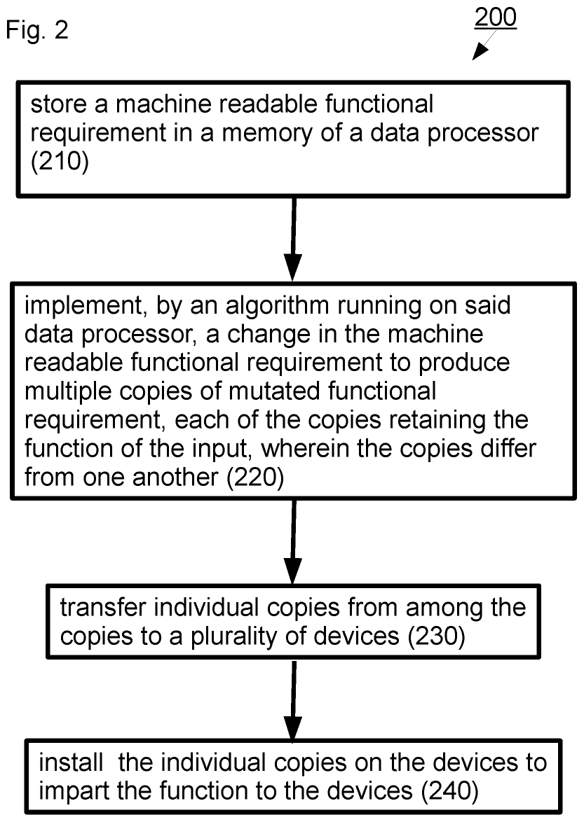

FIG. 2 is a simplified flow diagram of a method, indicated generally as 200, for introducing code variance into a population of similar devices according to some exemplary embodiments of the invention.

Depicted method 200 includes storing 210 a machine-readable functional requirement in a memory of a data processor and implementing 220 (by an algorithm running on the data processor) a change in the machine-readable functional requirement to produce multiple copies of mutated functional requirement. Each of the copies retains the function of the input stored at 210 although the copies differ from one another.

In the depicted embodiment, method 200 includes transferring 230 individual copies from among said copies to a plurality of devices and installing said individual copies on said devices to impart said function to said devices.

In some exemplary embodiments of the invention, the input stored at 210 is a functional requirement for an operating system (e.g. WINDOWS, ANDROID or IOS). In other exemplary embodiments of the invention, the input stored at 210 is a functional requirement for an application (e.g. a web browser, e-mail application, banking application, remote control application (e.g. for a smart car or smart home or contacts manager)). In other exemplary embodiments of the invention, the input stored at 210 is a functional requirement for the entire image of an IoT device, including, but not limited to operating system and one or more applications (e.g. IoT temperature sensor).

Alternatively or additionally, in some embodiments transferring 230 is a push transfer. For example, in some embodiments method 200 is practiced at a factory manufacturing self-driving cars and transferring 230 is performed at the factory to install the operating system in the onboard computer of each car.

Alternatively or additionally, in some embodiments transferring 230 is a pull transfer. For example, a commercial bank offers an ANDROID OS compatible application for download via its server. Copies of the application are prepared as described at 220 and stored on the server. Transfer 230 occurs in response to requests from banking customers to download the application.

Alternatively or additionally, in some embodiments an IoT device can be updated over the air (OTA), and may store several mutated copies of binary image (device code) with identical functionality. In one scenario, the device chooses from and exchange images when under attack or breached, while retaining original functionality.

In some exemplary embodiments of the invention, the machine-readable functional requirement (stored at 210) includes software code (source code) and method 200 includes compiling the copies produced at 220 to produce binary code.

In some exemplary embodiments of the invention, the input (stored at 210) includes binary code.

Alternatively or additionally, in some embodiments the plurality of devices includes Internet of Things (IOT) device. In some embodiments, the output is self-extracting and/or self-installing.

Alternatively or additionally, in some embodiments the copies of the output are used successively by a same device. For example, in some embodiments an on-line banking application residing on a user client device (e.g. a smart phone) runs a different copy (with a different mutation or set of mutations) of code for successive transactions. Alternatively or additionally, a bank server runs a different copy (with a different mutation or set of mutations) of code for successive transactions.

### Exemplary Change (Mutation) Types

In the context of methods 100 and 200 as described above, at least the following types of changes can alter the coding of the functional requirement while preserving its function (mutation).

In some exemplary embodiments of the invention, the algorithm running on the data processor changes the functional requirement by changing the functional requirement in a way that results in changing the offset in the product binary (320a).

Alternatively or additionally, in some embodiments the algorithm running on the data processor employs a random number generator to change the functional requirements. In some embodiments, the algorithm employs two or more random number generation mechanisms to mutate the random number generator and change said functional requirements.

Alternatively or additionally, in some embodiments the algorithm running on the data processor modifies the behavior and algorithm of a random number generator in the functional requirements. In some embodiments, the algorithm employs two or more random number generation mechanisms to replace a single random number generator in said functional requirements. A random number generator is a code algorithm employing a mathematical equation starting with a given number and in which, the mathematical permutations determine the next number in the series. Typically, random number generators use data from clock, temperature etc. and once decrypted, a pattern of numbers emerges. In some embodiments, the mutation is achieved by changing the functionality of the random number generator, making it difficult for attackers to understand the internal behavior of the system. For example, generation of encryption keys that may use a randomization mechanism internally.

Alternatively or additionally, in some embodiments the algorithm running on the data processor employs different memory locations for a same block of code in each copy.

Alternatively or additionally, in some embodiments the algorithm running on the data processor splits one or more buffers into multiple memory locations.

Exemplary System

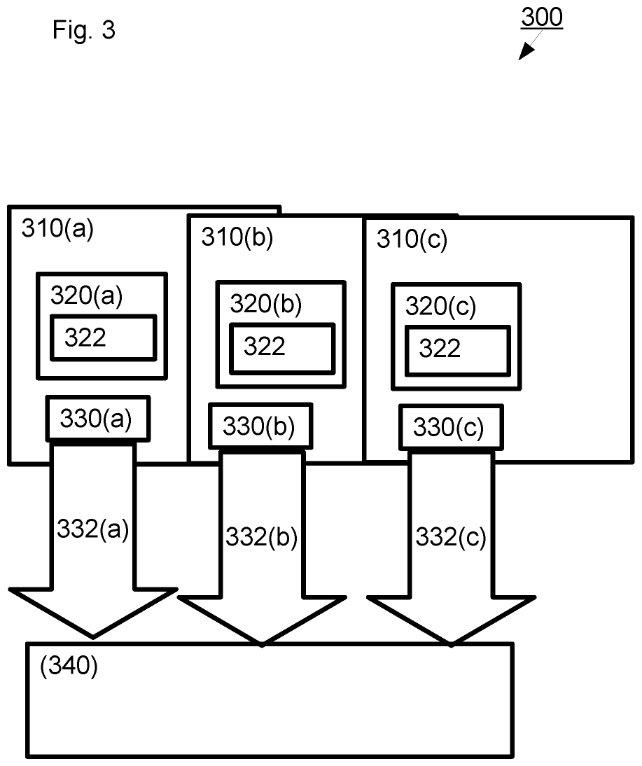

FIG. 3 is a schematic representation of a system protected against cyber-attack, indicated generally as 300, according to some exemplary embodiments of the invention.

Depicted system 300 includes a plurality of data processing devices (310(a); 310(b) and 310(c)) running binary code (320(a); 320(b) and 320(c)) to perform a same function 322. Note that although code 320 is present in different versions, function 322 is the same in all the devices. Ways to achieve this are described hereinabove in the context of methods 100 and 200 (FIGS. 1 and 2 respectively). Although three data processing devices are depicted for clarity, a much larger number will often be present.

Regardless of the number of devices, at least one of the devices runs binary code 320(a) which is different from binary code on at least one other device (320(b) or 320(c) to perform the same function 322.

In the depicted embodiment, an output module (330(a); 330(b) and 330(c)) on each of the devices transfers output (332(a); 332(b) and 332(c)) in a same format to a remote server 340.

According to various exemplary embodiments of the invention the data processing devices (310(a); 310(b) and 310(c)) include IOT devices and/or devices in a Mesh network and/or devices having user input (e.g. from a terminal) and/or servers. In some exemplary embodiments of the invention, the plurality of data processing devices includes Internet of Things (IOT) devices.

Exemplary IOT (Internet of Things) Device Types

The various embodiments of the invention described hereinabove are expected to find utility in IOT devices (as well as in other contexts). For purposes of this specification and the accompanying claims, the term “IOT device” includes, but is not limited to devices residing in a vehicle (e.g. onboard computers, navigation systems, communication systems and entertainment systems), medical devices, smart home systems (e.g. alarm system or remotely activated door lock control or temperature sensor) and industrial sensors (e.g. moisture sensors, temperature sensors and other sensing devices mounted on industrial machines).

For purposes of this specification and the accompanying claims, the term “vehicle” includes, but is not limited to cars (conventional and/or autonomous), trucks, buses, trains, aircraft (conventional and/or remote controlled and/or autonomous) and watercraft (e.g. boats and/or submarines)

First Exemplary Change (Mutation) Strategy

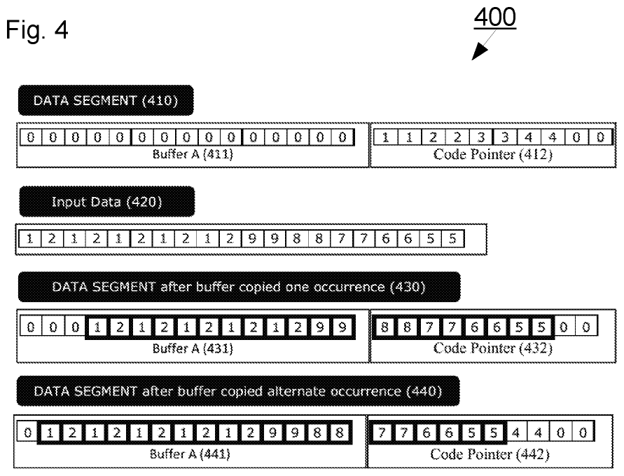

FIG. 4 is a schematic representation of RAM memory, indicated generally as 400, which is managed during software runtime, demonstrating alternating behavior during runtime within a given machine-readable functional requirement.

FIG. 4 depicts an exemplary implementation of a change (mutation) in code, which preservers function. The size of Buffer A (411) is set at 10 but the mutation algorithm reserves memory cells for Buffer A (411). Even though Input Data (420) exceeds the reserved size and continues to overwrite Code Pointer (412), the security of the system is increased because the algorithm stores Input Data (420) beginning with an un-consistent memory location within Buffer A (411).

The first time (430) the algorithm copies input data (420) into Buffer A (431) the data is offset by three memory cells with respect to the beginning of the buffer. This causes an overwrite of eight memory locations of Code Pointer (432).

The next time (440) the algorithm copies input data (420) into Buffer A (441) the data is offset by one memory cell with respect to the beginning of the buffer. This causes an overwrite of six memory locations of Code Pointer (442).

This variance (compare 420; 430 and 440) means that an Attacker cannot predict which offset of Input Data (420) corresponds to the beginning of the Code Pointer and therefore cannot effectively dictate the value that will be overwritten to Code Pointer (412) that defines an area of code to be executed.

Second Exemplary Change (Mutation) Strategy

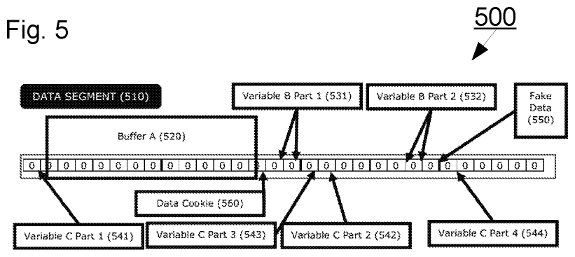

FIG. 5 is a schematic representation of RAM memory, indicated generally as 500, demonstrating mutated behavior during runtime within a given machine-readable functional requirement, after mutation according to exemplary embodiments of the invention.

FIG. 5 depicts a memory layout useful in the context of the present invention. Data Segment (510) contains an un-fragmented Buffer A (520).
Variable B is divided into two parts:
Variable B Part 1 (531) made of two memory cells, and
Variable B Part 2 (532) is made of two memory cells.

The two parts of Variable B are not located in a single Memory Block.

Variable C also is fragmented into four different parts using a similar technique:
Variable C Part 1 (541),
Variable C Part 2 (542),
Variable C Part 3 (543), and
Variable C Part 4 (544).

Variable C Part 1 (541) is located before Buffer A (520) and Variable C Part 3 (543) is located after Buffer A (520).

This means that a single Buffer Overflow Attack performed on Buffer A (520) is not expected to overwrite both parts of Variable C because the Attacker needs to overflow positive offset to overwrite Variable C Part 3 (543), but underflow negative offset to overwrite Variable C Part 1 (541).

This dramatically complicates the Attack and makes success less likely.

FIG. 5 also demonstrates Fake Data (550) which is implanted by the algorithm referred to hereinabove. Fake Data (550) is useful if an Attacker finds a way to read a Memory Block. Use of Fake Data makes it is harder for an Attacker to assume which areas of memory are in use and which are not, especially when modified during runtime, side by side with the real data. In some scenarios, prior to overwriting a memory buffer, an attacker will read the memory, in an attempt to gain insight into memory layout. Fake data, which changes in response to events, makes it difficult for the attacker to understand the correlation between memory areas and functionality.

In the depicted embodiment, Data Segment (510) also contains Data Cookie (560) located between Buffer A (520) and other data such as Variable B Part 1 (531).

Before using Variable B and Variable C, and any of their parts, Data Cookie (560) is verified for integrity. The data in the Data Cookie can be for example the result of a computation based on the Memory Address in which the Data Cookie is stored. In some embodiments verification of the Data Cookie is performed by recalculating the same number and comparing it to the data stored in the Data Cookie. The data generation mechanism for Data Cookie can be varied as part of Code Mutation. Corruption of Data in Cookies on Data Segment (510) indicates a Buffer Overrun and suggests that data after the corrupt Data Cookie is also corrupt. In some embodiments, when a Buffer overrun is detected, the system resets, thus defending itself from using malicious or manipulated data. In another embodiment, another copy of the Data near the Data Cookie is located in an unrelated memory location, which can also be verified, and the corrupt Data can be overwritten with the correct Data.

Additional Exemplary Change (Mutation) Strategies

According to various exemplary embodiments of the invention the layout of memory can have varies according to Static Code Variance and/or Static Behavior Variance and/or Dynamic Behavior Variance.

Exemplary Input and Output Formats

Table 1 illustrates input and output formats according to various exemplary embodiments of the invention.

TABLE 1
exemplary input and output formats

| INPUT | OUTPUT |
|---|---|
| binary code + mutation metadata | binary code |
| binary code | binary code |
| source code | source code |
| source code | binary code |
| source code + mutation metadata | source code |
| source code + mutation metadata | binary code |
| binary description | binary description |
| binary description | source code |
| binary description | binary code |

Binary code refers to instructions that the processor executes (“machine code”).

Source code refers to instructions in a programming language (e.g. C++, Java, visual basic, FORTRAN, and Pascal). Binary description refers to a digital description of requirements. For example, information stored by a GUI that allows users to select options, which can be saved as a binary collection containing selected items. Mutation Metadata refers to information required by a mutation mechanism. By going over the binary code, we can identify the CPU instruction “Call” which identifies the beginning of a function, allowing us to break the code into discrete areas which can be rearranged in order to produce a mutated binary image.

In some embodiments, compiling generates binary output in the same order as it appears in the Source Code. Therefore, for example, introducing variance in the order of functions in the Source Code changes the order of functions in the binary output. Furthermore, introducing variance in the order in which variables are declared in Source Code will cause variance in the binary output.

Different human software developers can create different versions of Source Code that perform the same functionality, resulting in various different binaries performing the same functionality. The code that knows how to write the data, also knows how to read the data. Every given processor has a simple binary-executable file intended for that processor. The attacker's goal is knowing the internal behavior of the data processor as it executes the software. This knowledge applies to all devices using the same binary image. According to various exemplary embodiments of the invention, variance is introduced into code so that an attacker that knows the internal behavior of one image does not have enough knowledge to attack another device using a mutated image.

The principles and operation of a method and/or system according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

It is expected that during the life of this patent many programming languages, operating systems, programming techniques, software production tools and device types will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and do not limit the scope of the invention, which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of IOT devices but might also be used in Internet browsers running on conventional computers or smart devices and/or in electronic banking transactions.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-81. (canceled)

82. A system configured to prevent a security breach, comprising:
a plurality of devices, wherein each device of the plurality of devices has at least one processor;
wherein a device of the plurality of devices is configured to:
receive an input having a functional requirement;
generate at least one mutated copy of said input, said at least one mutated copy retains said functional requirement when modifying data of said input; and,
transmit said at least one mutated copy to at least one device of the plurality of devices.

83. A system according to claim 82, wherein an iterative launch of said functional requirement generates the at least one mutated copy.

84. A system according to claim 82, wherein mutated copy is generated by offsetting a predetermined number of memory cells with respect to a buffer beginning of a memory bank of said mutated copy.

85. A system according to claim 84, wherein said offset results in overwriting a code pointer by a predetermined number of memory locations.

86. A system according to claim 84, wherein the device is further configured to implant fake data into a memory block of said mutated copy to generate said offset.

87. A system according to claim 86, wherein the device is further configured to modify said fake data responsive to an attempt to breach security of the device.

88. A system according to claim 86, wherein compliance is maintained with a device interface while alternating said input.

89. A system according to claim 82, wherein each device of said plurality of devices is configured to:
receive said at least one mutated copy;
generate at least one new mutated copy retaining said functional requirement; and,
transmit said at least one new mutated copy to said at least one device.

90. A system according to claim 89, wherein said each device selects a mutated copy from said at least one mutated copies responsive to an event according.

91. A system according to claim 82, wherein said at least one mutated copy is generated responsive to an event.

92. A method using at least one hardware processor, comprising:
receiving an input having a functional requirement;
generating at least one mutated copy of said input that retains said functional requirement;
providing said at least one mutated copy to a plurality of devices, each device having at least one hardware processor.

93. A method according to claim 92, wherein activation of said functional requirement generates said at least one mutated copy.

94. A method according to claim 92, wherein mutated copy is generated by offsetting a predetermined number of memory cells with respect to a buffer beginning of a memory bank of said mutated copy.

95. A method according to claim 94, wherein said offset results in overwriting a code pointer by a predetermined number of memory locations.

96. A method according to claim 94, further comprising implanting fake data into a memory block of said mutated copy to generate said offset.

97. A method according to claim 96, further comprising modifying said fake data responsive to an attempt to breach security of the device.

98. A method according to claim 96, wherein compliance is maintained with a device interface while alternating said input.

99. A method according to claim 94, wherein said offsetting is performed in a random manner.

100. A method according to claim 92, wherein said at least one mutated copy is generated responsive to an event.

101. A method according to claim 92, wherein said mutated copies comprises data cookies to enable devices to verify said mutated copy is not corrupt.
